(19) United States
(12) Patent Application Publication
(10) Pub. No.: US 2026/0220152 A1
(43) Pub. Date: Jul. 30, 2026

(54) PROVIDING STRUCTURE AND ACCESSIBILITY TO LARGE VOLUMES OF UNSTRUCTURED DATA

(71) Applicant: Dimension, Inc., Las Vegas, NV (US)

(72) Inventor: James B. Anderson, Minneapolis, MN (US)

(73) Assignee: Dimension, Inc., Las Vegas, NV (US)

(21) Appl. No.: 19/227,446

(22) Filed: Jun. 3, 2025

Related U.S. Application Data
(60) Provisional application No. 63/655,533, filed on Jun. 3, 2024.
(60) Provisional application No. 63/667,676, filed on Jul. 3, 2024.
(60) Provisional application No. 63/678,009, filed on Jul. 31, 2024.

(51) Int. Cl. G06F 16/25; G06F 16/28; G06F 16/901

(52) U.S. Cl. CPC G06F 16/258; G06F 16/284; G06F 16/9024

(57) ABSTRACT

Systems, processes, devices, and implementing technologies for organizing, searching, analyzing, and retrieving previously unstructured data obtained from one or more databases of voluminous unstructured data (“BigData”), including data in video/image/audio (VIA data) format. Where analysis of BigData is considered, there are preferably three component processes comprising any complete BidData Software Solution including (i) an organization component or processes, termed BigData Assembly (BDA), (ii) an exploration component or processes, termed BigData Exploration (BDE), and (iii) a discovery component or processes, termed BigData Discovery (BDD). Superresolution-enabled (SRE) video processing is used to provide structure and accessibility to such VIA data.

### CROSS REFERENCE TO RELATED APPLICATION

This application claims priority benefit under 35 U.S.C. § 119 (e) to U.S. Provisional Patent Application Nos. 63/655,533, entitled “SREC-Enabled System for Big Data Assembly,” filed Jun. 3, 2024, U.S. Provisional Patent Application Nos. 63/667,676, entitled “SREC-Enabled System for Big Data Exploration,” filed Jul. 3, 2024, and U.S. Provisional Patent Application Nos. 63/678,009, entitled “SREC-Enabled System for Big Data Discovery,” filed Jul. 31, 2024, all of which are hereby incorporated by reference in their entirety, as if set forth in full herein.

### FIELD OF THE INVENTION

The present inventions relate generally to systems, processes, devices, and implementing technologies for organizing, searching, analyzing, and retrieving previously unstructured data and, more particularly, to use of superresolution-enabled (SRE) video processing to provide structure and accessibility to voluminous amounts of data, including data in video/image/audio format (“VIA data”).

### BACKGROUND OF THE INVENTION

Terminology: Terms and acronyms used herein, and in related applications and issued patents, include but are not limited to: Artificial Intelligence/Machine Learning (AI/ML), BigData or Big Data (BD), BigData Assembly (BDA), BigData Exploration (BDE), BigData Discovery (BDD), BigData Transportation (BDT), BigData CODEX (BD-CODEX). Conjunctive Normal Form (logical expression) (CNF), Disjunctive Normal Form (logical expression) (DNF), Entity-Attribute Graph (EAG), frames-per-second (FPS), High Performance Computation (HPC), Internet Service Provider (ISP), AI-system architecture Knowledge Base (KBASE), Keywords, Declaratives, Relations (KDR), Left-Hand-Side (equation) (LHS), Large-Language Model (LLM), Law of Large Numbers (statistics) (LLN), Open Systems Intercommunication (model) (OSI), Machine Learning (ML), AI-system executive controller (MONITOR), Natural Language Processing (NLP), Neural-Network (NN), AI-system ML/pattern classifier(s) (PATTERN), Relational Data-Base (RDB), Right-Hand-Side (equation) (RHS), Software-as-a-Service (Saas), AI-system nondeterministic search-engine (SEARCH), Relational database accessed via Structured Query Language transactions (SQL/DBASE), Structured Query Language (SQL), Relational Database Management System (RDBMS), Superresolution-Enabled Video CODEC (SREC), and Well-Formed Formula (WFF).

Additional terms and acronyms used herein, and in related applications and issued patents, include but are not limited to: image processing, video processing, video processing pipelines, modulation transfer functions, superresolution (SR), modulation invariance, resampling, video rescaling, nonlinear signal processing (NSP), photometric warp (p-Warp or PW), reconstruction filters, single-frame superresolution (SFSR), superresolution-enabled (SRE) CODECs, video surveillance system (VSS), pattern manifold assembly (PMA), pattern manifold noise-floor (PMNF), video CODECs, additive white Gaussian noise (AWGN), bandwidth reduction ratio (BRR), discrete cosine (spectral) transform (cosine basis) (DCT), edge-contour reconstruction filter (ECRF), fast Fourier (spectral) transform (sine/cosine basis) (FFT), graphics processor unit (GPU), multi-frame superresolution (MFSR), network file system (NFS), non-local (spatiotemporal) filter (NLF), over-the-air (OTA), pattern manifold assembly (PMA), pattern recognition engine (PRE), power spectral density (PSD), peak signal-to-noise ratio (PSNR) image similarity measure, quality-of-result (QoR), raised-cosine filter (RCF), resample scale (“zoom”) factor (RSF), superresolution (super-Nyquist) image processing (SRES), video conferencing system (VCS), video telephony system (VTS), far-infrared (FIR) systems, thermal/far-infrared (T/FIR) systems, near infrared imaging (NIRI), image processing chain, multidimensional filter, nonlocal filter, spatiotemporal filters and spatiotemporal noise filters, thermal imaging, video denoise, minimum mean-square-error (MMSE), Wiener filter, focal-plane array (FPA) sensors, and optical coherence tomography (OCT).

What exactly is “BigData” (BD)? Most generally, and as used herein, the term BigData references, within any group or collection of information, the entire body of data that might be rendered available for a specific purpose within a particular use or context (business, public, military, personal, governmental, etc.). It will be appreciated that any BD collective refers to any type or group of data, including text, audio, image, or video data. It then follows, if indeed this data is available to machine processing, there is a need to be able to apply software-based tools to such data using intelligent systems technology of one form or another. However, as the diverse nature of the BD collective is considered, it is also apparent that those elements comprising BigData are typically unlabeled in terms of container, format, content, and even location. In other words, this BigData is stored in a form that is fundamentally unstructured, and in absence of any organizing schema by which it might be searched and pertinent information extracted, the BD collective remains unavailable and, for practical purposes, unusable. Thus, the term BigData references something (e.g., information, data) that is real but often inaccessible in raw form.

Stated differently, BigData is the total set of digital communications that might be rendered as an information resource. The promise of BigData is then the imagined extraction of intelligence (or relevant information) based upon a highly diverse and essentially unbounded content that is also unstructured. Most generally, it is expected that the formal complexity associated with machine processing on any unstructured data will drive fundamental performance limits at scale.

From a market-sector perspective, BigData is a term commonly used in technical parlance, but upon more detailed investigation, it is apparent that no such thing actually exists. Rather, the term references a conceptual agglomeration of all information derived from the sum total of humanity's various electronic communications. A significant complication arises due to the fact that BigData is also unstructured based upon inclusion of not just textual data, but also video, image, and audio (“VIA”) data of widely varying container, content, and (CODEC) format. For example, it is estimated that more than 50% of what can be understood as BigData is actually video. Thus, any purported BigData ‘solution’ must accept each of the above data forms as valid input. It then follows, BigData must exist as a uniformly accessible data resource, assembly of which incorporates all aforementioned data categories. Given no such assembly is currently available, one might claim ‘BigData’ exists in principle, but not in fact. There is therefore a need to be able to assemble BigData into a format and structure that makes it accessible. Once accessible, there is then a need to be able to explore (BDE) and discover (BDD) relevant or desired information contained in such BigData, for numerous uses and purposes, as will be described in greater detail hereinafter.

The present inventions meet one or more of the above-referenced needs as described herein below in greater detail.

### SUMMARY OF THE INVENTIONS

The present inventions relate generally to systems, processes, devices, and implementing technologies for organizing, searching, analyzing, and retrieving previously unstructured data and, more particularly, to use of superresolution-enabled (SRE) video processing to provide structure and accessibility to voluminous amounts of data, including data in video/image/audio format (“VIA data”).

Where analysis of BigData is considered, there are preferably three component processes comprising any complete BidData Software Solution (“BDSS”): (i) organization (BigData Assembly; BDA), (ii) exploration (BigData Exploration; BDE), and (iii) discovery (BigData Discovery; BDD).

BigData Assembly (BDA) is initiated by a process whereby URL references along with a set of defining attributes are added to each BigData element in creation of an entity-attribute graph (EAG) representation, referred to as a DATAVERSE. This DATAVERSE is then further processed in creation of an SQL/RDBMS image (BD-CODEX) based upon mere appearances of keywords, simple declarative statements, logical relations on keywords, and ancillary data references that may in fact have evidentiary bearing upon the truth-value of a given conjecture. In this manner, a BigData organizational principle is expressed whereby BigData content is regenerated in an efficiently searchable form based upon metric relevance to a given BigData problem statement and interconnection with ancillary data elements. A key point is BDA enables efficient processing on BigData. In particular, nondeterministic searching is greatly accelerated via this representation. With assumption of BDA as a prior core process by which the BD-CODEX organizational schema is generated, one can then focus on extraction of intelligence from BigData via a process referred to as BigData Exploration (BDE).

BigData Exploration (BDE) is preferably an AI-based processing model whereby information pertinent to solution of a given BigData problem is extracted from a data repository. In this model, BDE is cast as a goal-directed search problem to which a highly flexible problem representation, fuzzy logic inference-engine, nondeterministic solution-search, and a hierarchical knowledge-base are applied. With assumption of the aforementioned BDE processing model, a software architectural-form for BDE is used as the basis for applications development. As will be shown hereinafter, this form is not only capable of highly flexible and efficient information extraction, but also admits significant Amdahl process acceleration based upon parallelization of component threads appearing upon a process schedule. In BDE, a tailored evidentiary search mechanism is applied to an assumed set of keywords, simple declaratives, and relations between keywords, declaratives, and possibly other relations (“KDR”), as the basis for truth assessment on some user-supplied logical conjecture on data. This BDE architectural-form also features interprocess communication linkages as the basis for hierarchical integration of BDA, BDE, and BDD components in creation of a single, ‘total-solution’ BigData software application.

BigData Discovery (BDD) provides a means for expanding the KDR-set, augmenting the EAG representation, and modifying logical conjectures as an overarching discovery process that emerges within context of goal-directed, nondeterministic search on data.

BigData Assembly (BDA) is an AI-based machine process by which an unstructured DATAVERSE may be rendered in form of an entity-attribute graph (EAG) to which nondeterministic evidentiary search may be applied. This EAG is then rendered as an RDBMS image referenced as a BD-CODEX. This BD-CODEX then serves as a fully searchable problem-space representation for application of a second AI-based BigData Exploration (BDE) process by which information pertinent to a given problem statement is extracted in terms of rank-ordered appearance of some assumed set of keywords, declaratives, and relations (KDR). Accordingly, the BDE problem representation then accrues as BD-CODEX plus a user-supplied logical conjecture on KDR to which BDE applies an inference engine and knowledge-base representation for evidence-based calculation of truth-values on that conjecture. This is all performed within the context of BDE goal-directed nondeterministic search for which a solution-state may be achieved based upon statistical convergence of evidentiary support.

It is significant this goal-directed behavior is in fact a discovery process, the result of which may include KDR elements absent in the original problem statement. It then follows an existing problem statement must be expanded to provide representation for this new information. As described herein, a BigData Discovery (BDD) process supports iterative calls to BDA and BDE sufficient to what constitutes an evidence-based expansion of BD-CODEX and any assumed logical conjecture on BD-CODEX. In this case, an AI-based architectural form is indicated for BDD due to an essential nondeterminism arising in connection with any modification of the problem representation.

The aforementioned BDSS is thus revealed as a hierarchical AI system, a major advantage of which is creation of an integrated processing environment in which BDA, BDE, and BDD functionalities together comprise a total BigData solution.

The aspects of the invention also encompass a computer-readable medium having computer-executable instructions for performing methods of the present invention, and computer networks and other systems that implement the methods of the present invention.

The above features as well as additional features and aspects of the present invention are disclosed herein and will become apparent from the following description of preferred embodiments.

This summary is provided to introduce a selection of aspects and concepts in a simplified form that are further described below in the detailed description. This summary is not intended to identify key features or essential features of the claimed subject matter, nor is it intended to be used to limit the scope of the claimed subject matter.

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In addition, further features and benefits of the present technology will be apparent from a detailed description of preferred embodiments thereof taken in conjunction with the following drawings, wherein similar elements are referred to with similar reference numbers, and wherein:

FIG. 1(a) illustrates a BigData System Architecture with SREC Transport;

FIG. 1(b) illustrates an enhanced BigData System Architecture with SREC Transport;

FIG. 2 illustrates a basic BigData application suite model for use with the BigData Software System disclosed and described herein;

FIG. 3 illustrates a generic BDA/AI architectural form for use with the BigData System disclosed and described herein;

FIG. 4 illustrates a generic AI process model flow chart associated with the architectural form of FIG. 3;

FIG. 5 illustrates an exemplary BigData-CODEX/RDB record;

FIG. 6 illustrates a cloud-based BigData application suite model similar to that shown in FIG. 2;

FIG. 7 illustrates a BigData System AI Architectural Model incorporating BDE/AI and BDA/AI as subprocesses;

FIG. 8 illustrates a generic AI System Logic Flow for practicing the BDA and BDE processes described herein;

FIG. 9 illustrates an AI System Logic Flow with Evidentiary Search for practicing the BDA and BDE processes described herein;

FIG. 10 illustrates an improved AI System Logic Flow with Evidentiary Search for practicing the BDA and BDE processes described herein;

FIGS. 11(a) and 11(b) illustrate two variations of a BDE nondeterministic search in form of a state transition diagram;

FIG. 12(a) illustrates a generic BDE AI architectural form;

FIG. 12(b) illustrates a BDE-specific AI architectural form similar to the generic form of FIG. 12(a);

FIG. 12(c) illustrates a BDE-specific AI architectural form of FIG. 12(b) with user interface options shown;

FIG. 12(d) illustrates a BDD-specific AI architectural form similar to the generic form of FIG. 12(a);

FIG. 12(e) illustrates a BDDS-specific AI architectural form similar to the form of FIG. 12(d) with user interface options shown;

FIG. 13 illustrates a BDDS state transition diagram used with the architectural form of FIG. 12(e).

### DETAILED DESCRIPTION OF PREFERRED EMBODIMENTS

Before the present technologies, systems, devices, apparatuses, and methods are disclosed and described in greater detail hereinafter, it is to be understood that the present technologies, systems, devices, apparatuses, and methods are not limited to particular arrangements, specific components, or particular implementations. It is also to be understood that the terminology used herein is for the purpose of describing particular aspects and embodiments only and is not intended to be limiting.

As used in the specification and the appended claims, the singular forms “a,” “an,” and “the” include plural referents unless the context clearly dictates otherwise. Similarly, “optional” or “optionally” means that the subsequently described event or circumstance may or may not occur, and the description includes instances where the event or circumstance occurs and instances where it does not. Throughout the description and claims of this specification, the word “comprise” and variations of the word, such as “comprising” and “comprises,” mean “including but not limited to,” and is not intended to exclude, for example, other components, integers or steps. “Exemplary” means “an example of” and is not intended to convey an indication of preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference to each various individual and collective combinations and permutations of these cannot be explicitly disclosed, each is specifically contemplated and described herein, for all methods and systems. This applies to all aspects of this specification including, but not limited to, steps in disclosed methods. Thus, if there are a variety of additional steps that can be performed it is understood that each of the additional steps can be performed with any specific embodiment or combination of embodiments of the disclosed methods.

As will be appreciated by one skilled in the art, the methods and systems may take the form of an entirely new hardware embodiment, an entirely new software embodiment, or an embodiment combining new software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, non-volatile flash memory, CD-ROMs, optical storage devices, and/or magnetic storage devices.

Embodiments of the methods and systems are described below with reference to block diagrams and flowchart illustrations of methods, systems, apparatuses and computer program products. It will be understood that each block of the block diagrams and flow illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions, and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

### A. Overview

Where analysis of BigData is considered, there are preferably three component processes comprising any complete BigData Software Solution (BDSS): (i) organization (BigData Assembly; BDA), (ii) exploration (BigData Exploration; BDE), and (iii) discovery (BigData Discovery; BDD). Each of these component processes is described in greater detail hereinafter.

### B. BigData Assembly

The problem of rendering BigData amenable to efficient machine processing is arguably the most significant obstacle to BigData commercialization. This problem of rendering BigData amenable to efficient machine processing is addressed as one of BigData Assembly (BDA). The BDA problem is addressed via an organizing principle to be applied to the BigData collective in creation of a BD-CODEX. As conceived, BDA generates a BD-CODEX and in doing so renders a given body of data as an efficiently searchable resource, here in form of a relational database image. As will be seen, BDA is itself performed via a nondeterministic exploratory search applied to elements comprising the BD collective. This search is constituted of AI-generated web-queries on some a priori defined set of keywords, declaratives, and defined relations thereof. Within this context, AI/KBASE production-rule content assures direct relevance of any generated BD-CODEX to a given BigData problem definition. In essence, relevant structure is discovered and captured in BD-CODEX form. This BD-CODEX then defines a searchable BD datapool to which further analyses may be applied.

‘BigData’ generally implies lots of data-much (estimated at greater than 50%) of which is in the form of video. Thus, follow-on problems of efficient transmission and storage of cached data-content (i.e., as indexed by BD-CODEX) naturally arise. As described hereinafter, these problems are addressed via integration of a Superresolution-Enabled Video CODEC (SREC), as described in U.S. Patent Application Publication No. US 2023/0232050 A1, entitled “Improved Superresolution-Enabled (SRE) Video CODEC, published Jul. 20, 2023, which is incorporated herein by reference, in its entirety, within context of an overarching BigData Assembly (BDA) system.

As indicated above, a preponderance of all BigData exists in the form of video. It then follows that those interested in BigData exploration are highly motivated to include video content. Two problems immediately arise in this context: (i) dataset assembly, and (ii) data extraction. In order for BigData to be explored or discovered, it is first necessary to assemble ultra-large-scale datasets of information, particularly in video format.

BigData is often touted as a global, all-encompassing information resource. Market opportunity for BigData applications is typically cited within the context of an enhanced business information capability, presumably to be leveraged as the basis for improved business decisions. However, no matter the specific application domain, BigData Exploration is uniform in extraction of entity-attribute graphs (i.e. as an information representational form) from this amorphous thing called ‘BigData’. Use of the term ‘amorphous’ is purposeful in casting BigData as an unstructured organization of unstructured data, a claim for which an unbridled diversity of form and content lends credence. Thus, if one accepts that BigData is fundamentally unstructured, a question remains as to some means by which this requisite structure may be obtained within the context of exploratory analyses. As on surveys the entire BigData market sector, it would appear this is a basic challenge to be faced by each and every prospective user requiring access to BigData. This challenge is addressed herein via introduction of a two-pronged innovative approach within the AI/BigData market sector: (i) system architecture for generation and efficient management of structured BigData resources, and (ii) an AI-based software application as a system-component capable of an autonomous structuring of raw BigData resources.

Use of the phrase ‘autonomous structuring’ is purposeful and implies that any such process will exhibit a high-order formal complexity that is generally unsuited to human intervention. In particular, this complexity is reflected in both data volume and organization (i.e., network localization plus references). In the former, one is concerned with the amount of data being processed, and in the latter one is concerned with the diversity of interrelationships exhibited by the data. On this basis alone, any meaningful processing will require substantial automation. Further, this automation will enable BDA/BDE concurrency by which an Amdahl (parallel-processing) gain may be achieved for most efficient machine processing. Thus, it is envisioned that an autonomous or semi-autonomous BDA process occurs prior to and also within context of BDE.

The problem of BigData Assembly is twofold: (i) identify and locate data resources and (ii) propagate the data as needed to some processing locus whereupon information is to be extracted. In this case, the former remains a matter of resource mapping and the latter a matter of data transmission.

In the current marketplace, BigData resource mapping remains undefined. For example, if one were to ask an individual well-versed in the art, “Where exactly is this BigData of which you have been speaking?” the individual likely would not be able to provide an answer, or the answer they give would be something akin to “Perform a web-search.” Obviously, the former is no solution at all, and the latter remains in-principle doable but also completely non-scalable. In particular, an uninformed web-search is known to exhibit a formal complexity that is completely unmanageable at scale. It then follows, where BigData is considered, one cannot expect users to solve the resource mapping problem. Further, once data resource-mapping has been achieved, a question still remains as to any requisite data movement or storage, (e.g., for purposes of local data extraction and detailed analyses). In particular, where massive video datasets are envisioned, one cannot expect customers to absorb costs associated with what would be full-bandwidth data transmission and storage of acquired data elements.

It is apparent that any viable BigData solution in the marketplace must be scalable and this scalability demands an upfront, minimum complexity solution of two ancillary problems: (i) data resource mapping (i.e. “where to go” for data) and (ii) data transmission and storage resource management. As described herein, a distinct solution is proposed for each. In the former, a new BigData Assembly (BDA) application domain is envisioned, and in the latter a superresolution-enabled video CODEC (SREC) is incorporated so as to reduce overall transmission rate and storage requirements.

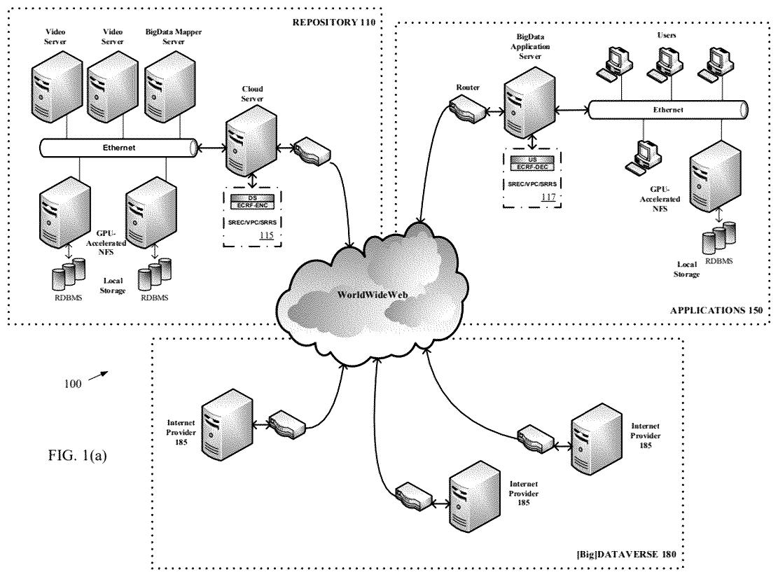

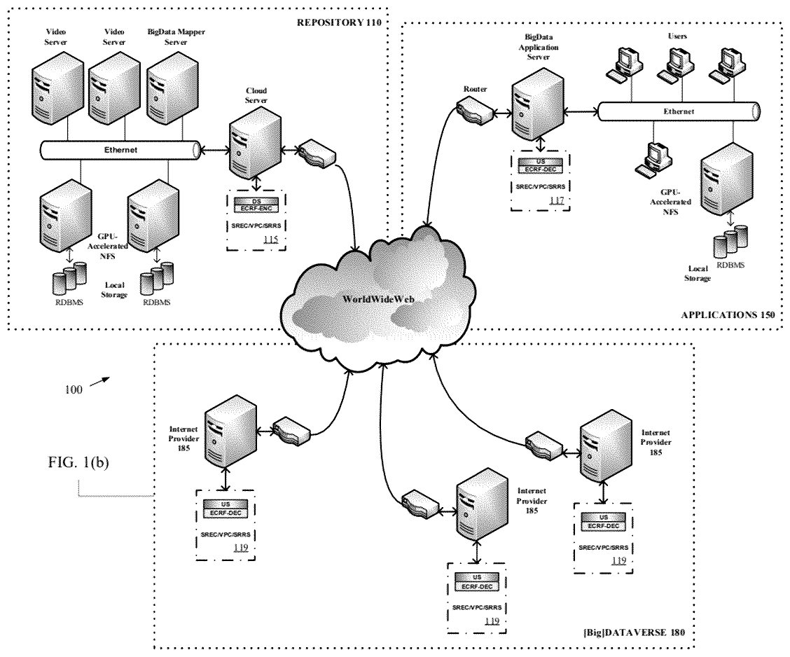

Turning now to the drawings, as shown in FIGS. 1(a) and 1(b), the proposed BigData System 100 described herein features three major components; (i) REPOSITORY 110, (ii) APPLICATIONS 150, and (iii) DATAVERSE 180. In this system 100, BigData Exploration and applications-level data requests are serviced exclusively by REPOSITORY 110, here in the form of a SaaS resource responsible for mapping required DATAVERSE data-resources and caching data-elements in a compressed SREC format 115. In this manner, unstructured queries to BDVERSE are eliminated. It is also noted that data-resource mapping is performed by the selfsame repository SaaS resource, but here based upon maximally efficient nondeterministic search, per keywords, declaratives, and relations (KDR) supplied by one or more application components.

It should also be noted that use of an SREC data representational form 115,117 implies minimization of data transmission, storage, and caching requirements within context of applications processing. In effect, REPOSITORY 110 converts all video content to SREC format 115 for transmission and storage. As an aside, this may be implemented with introduction of a new container file format featuring explicit representation of SREC layer-1 datafields, or possibly via reuse of an existing container (e.g. MPEG-4/5) accompanied by SREC layer-1 data encoded as SREC layer-2 metadata.

As shown in FIG. 1(a), SREC infrastructure is reserved to REPOSITORY 110 and APPLICATIONS 150. This implies the nondeterministic search performed within context of data resource mapping accrues at least in part at full bandwidth or file size. However, as shown in FIG. 1(b), all advantages of SREC-based REPOSITORY/APPLICATIONS data movement and archival may be extended to the BDVERSE 180 entire with introduction of a small SaaS applications layer 119, along with SREC transport at all internet service providers (ISP) 185. In this manner, full-bandwidth data transmission and storage are completely avoided within context of BigData Exploration and analysis.

Since the preponderance of BigData content is actually in the form of video, the architectures displayed in FIGS. 1(a) and 1(b) are useful where those large (video) datasets typical of BigData must be processed and archived. In particular, use of a superresolution-enabled video CODEC previously referenced enables leveraging of maximally compressed video streams in terms of transmission, processing, and archival storage. This is of course a major advantage but also presupposes the data required is already ‘in-hand’. That is to say, the data is already available as an indexable resource in terms of URL (e.g. ‘location’), container, content, etc. Stated differently, to perform any analysis upon this data, it is necessary to know where the data is and how to extract the information required. In short, the data must first be organized in an indexable form. In what follows, this process of usefully organizing BigData as BigData-Assembly (‘BD-Assembly’ or ‘BDA’), it is apparent that efficient transport alone will not solve these problems. Rather, these issues must be addressed at the application level.

It is then apparent, given the unstructured nature of BigData, any BigData application-suite must necessarily incorporate capability to organize raw BigData in a manner that enables nondeterministic search and efficient processing within context of those exploratory analyses that are desirable to be performed. This problem is daunting for two reasons: (i) the intrinsic formal complexity of any such data organization and (ii) the exascale nature of BigData. As will be appreciated by one skilled in the art, an unaided human agent cannot be expected to devise and implement web searches sufficient to this purpose. Thus, the BD Assembly processes and components described hereinafter present an evolutionary and autonomous process to be implemented before BD Exploration and Discovery can be undertaken.

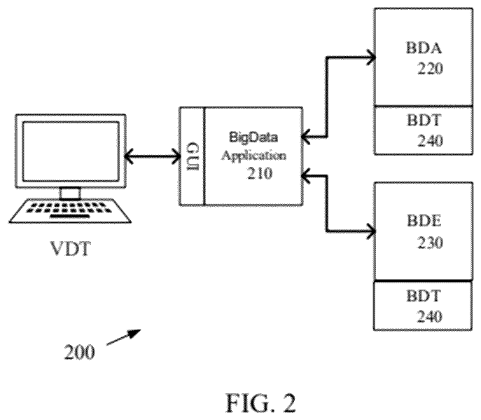

As previously discussed, the BigData problem is comprised of three subproblems: (i) BD-Transport (BDT), (ii) BD Assembly (BDA), and (iii) BD-Exploration (BDE). BDE is discussed in greater detail below. BDT has already been addressed at a hardware level with introduction of an OSI transport-layer featuring enhanced video compression, as described with reference to FIGS. 1(a) and 1(b), and with reference to SREC processes described in the incorporated patent publication. However, as discussed herein, BDT, BDA, and BDE functionalities remain present at the OSI application-layer. Given BDA takes place prior to BDE, each of these are rendered as independent tasks. However, calls to BDT resources will be made by both BDE and BDA, albeit for distinct purposes. The upshot is BDT is a subprocess for both BDE and BDA. This structure is displayed in block-diagram form 200 in FIG. 2. A key take-away is any BigData application 210, having a conventional user interface, consists of BDA and BDE application components 220,230, respectively, each of which accesses BDT functionality 240.

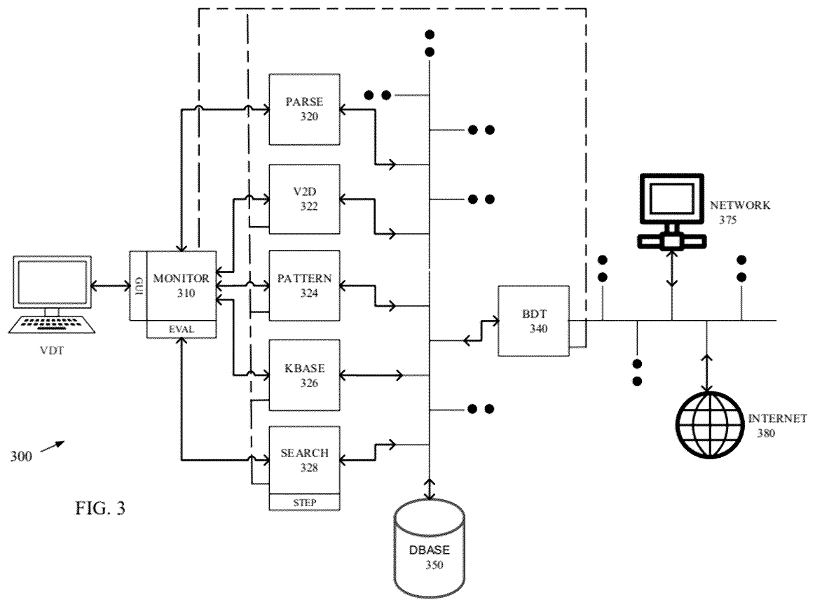

Turning now to the specific problem of BD Assembly, it is assumed that implementation is in the form of an AI-based application (“BDA/AI”), the generic form 300 of which is displayed in FIG. 3, with descriptions of each block component as follows. The generic BDA/AI 300 includes a MONITOR component 310, which provides AI Executive Control, including problem description/system state evaluation and task-queue assembly. The MONITOR component 310 interfaces with a PARSE component 320, a V2D component 322, a PATTERN component 324, a KBASE component 326, and a SEARCH component 328. The PARSE component 320 provides NLP-based syntactic analysis; the V2D component 322 provides Video-to-Data conversion, including object detection and dynamical content-analysis; the PATTERN component 324 provides ML/NN-based pattern recognition/classification; the KBASE component 326 provides Knowledge-Base, including production-rules and inference engine; and the SEARCH component 328 provides solution-space representation, including a nondeterministic search engine. The BDA/AI 300 further includes a BDT component 340, which provides the OSI transport-layer, which includes DATAVERSE access and video READ/WRITE/ARCHIVE w/compression. The BDT component 340 interfaces with relevant external networks 375 and the Internet 380. All of the components of the BDA/AI 300 have access to a database 350.

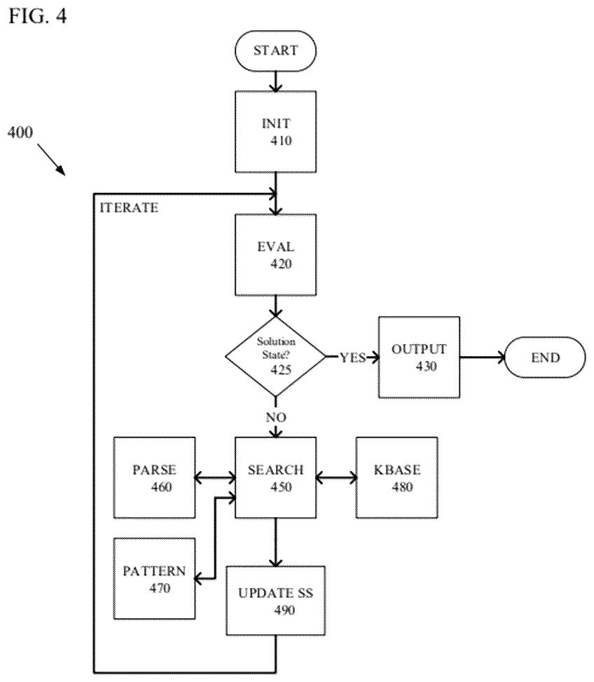

The specific advantage to be gained by adoption of an AI architectural form is the implicit casting of DATAVERSE organization as a problem of nondeterministic search (SEARCH) with application of domain-specific knowledge elements (KBASE) to that search according to the generic AI processing model 400 displayed in FIG. 4.

As shown in FIG. 4, a generic AI processing narrative or model 400 includes the following steps: the system is initialized (Step 410) with application of state-variable defaults [INIT], the data is evaluated (Step 420) [EVALUATE] to determine if there is a solution state (Step 425). If the determination at Step 425 is YES, then the successful results are output (Step 430) [OUTPUT] and the process 400 terminates [END]. If the determination at Step 425 is NO, then the state in solution search space is incremented (Step 450) [SEARCH]. Then, the input datasets are assembled (Step 460) [PARSE] and pattern analyses is performed (Step 470) [PATTERN]. All knowledge-base variables are updated (Step 480) with classifier outputs [KBASE] and the solution state is updated (Step 490) and the process returns to Step 420 for further evaluation based on the updated solution state [ITERATE].

This generic processing model 400 from FIG. 4 is rendered specific to BDA in the BDA/AI process narrative that follows: At Step 410 [INIT], the system is initialized and starts with an assumed KDR-set, [e.g., possibly generated via PARSE on local data, or perhaps an existing BD-CODEX to be extended]. At Step 420 [EVAL], the solution-state is tested/evaluated (e.g., there are many possibilities depending upon BDA problem definition-one possibility is mapping of a DATAVERSE-element set of order sufficient to BDE invocation). If the determination at Step 425 is YES, then the BD-CODEX is output (Step 430) and the process 400 ends. If the determination at Step 425 is NO, then the SEARCH Step 450 is taken, which generates a new web-query transactions per KBASE. A set of returned URL references is assembled and iterated, V2D is invoked as needed and KDR/PARSE is performed on content (Step 460), correlation statistics are generated and pattern analyses on generated frequency of occurrence data is performed [PATTERN] (Step 470), the KBASE is updated with classifier outputs (Step 480), and the BD-CODEX/RDB image is updated (Step 490). The process returns to Step 420 for further evaluation based on the updated BD-CODEX/RDB image [ITERATE].

With this process narrative in hand and recalling what is known of BD Exploration, this results in a rather startling conclusion. At a machine-processing level-of-abstraction, BD Assembly is rendered identical to BD Exploration, and it is this identity that motivates use of a common architectural form for each. This is both interesting and useful. However, despite any assumption of a common architectural form, BD Exploration and BD Assembly also represent distinct problem statements and on this basis alone, one can expect substantial differences in terms of subprocesses, problem representation, knowledge-base content and organization, state representation and transitions, etc. As discussed herein, BD Exploration is a process by which selected keywords, declaratives, and relations (KDR) are ‘scraped’ from BD content. Similarly, BD Assembly is itself a process by which a BD datapool is ‘scraped’ from DATAVERSE, the result of which is creation of a BD-CODEX. This BD-CODEX then provides the requisite indexing framework as a basis for nondeterministic search in connection with any specified BD Exploration task. This BD-CODEX structure created within context of BD Assembly is shown herein to have direct bearing upon the efficiency and scalability with which BD Exploration might be performed.

As described, BDA may be regarded as a mapping function applied to raw, untamed BDVERSE data. As narrated, BDA is BDVERSE Exploration based upon nondeterministic search for pertinent KDR data. It is also noted that newly identified resources are mapped as discovered. That is to say, the BD-CODEX/RDB image is extended as new data resources are identified and vetted per KBASE encoding of data-attributes indicating useful or relevant content. It is also significant that this extension is not restricted to the initial KDR-set, as KBASE may encode an extended set of conditions under which KDR-element discovery is performed. In such case, BD-CODEX/RDB is extended based upon an augmented KDR-set. Once complete, BDA returns a complete BD-CODEX/RDB subsequently passed to BDE as basis for an extended exploratory analyses.

With regard to AI processing complexity, BDA/AI is quite simple in terms of problem statement and logical flow. Thus, BDA/AI may be considered a thin-client AI within context of the BD application model displayed in FIG. 2. However, as previously noted, BDA processing is expected to exhibit a formal complexity inappropriate to processing that might require human-intervention. That is to say, the nature of BD-CODEX generation is such, while BDA is appropriately invoked or controlled via a user's graphical user interface (GUI), BDA is also not a problem to be solved via GUI. Arguably, this is wholly consistent with the characterization of BigData processing as inherently exascale. The upshot is BDA is appropriately performed as a background, autonomous process. Under such circumstances, human intervention is not required. However, it is also true that human expertise is required, but we have already assumed that expertise is captured in AI/KBASE, part and parcel of the present AI system design and implementation. In simplest terms, once BDA processing is initiated, that process runs to completion, and finally a BD-CODEX output is generated and subsequently read as input to BDE. Of course, this simple sequence may be repeated as often as necessary to achieve a desired result.

BD-CODEX Structure. As described above, BD-CODEX forms a referential superstructure that enables indexing of raw DATAVERSE resources. As described herein, the term ‘indexing’ is understood to imply hierarchical organization and a graph-theoretic schema for traversing and extending that hierarchy within context of nondeterministic search. Intuitively, BD-CODEX is expected to provide the following information: (a) location of resource; (b) available content; and (c) pointers to additional resources.

As such, BD-CODEX exhibits a graph-theoretic structure that is both hierarchical and traversable by which one is able to: (i) access a given resource, (ii) reference available content, and then (if so desired) (iii) traverse the graph structure to access further resources. As described above, this BD-CODEX is itself generated by the BDA Application via exploratory nondeterministic search conditioned upon some assumed set of keywords, declaratives, and relations (KDR). In present context, use of the term ‘exploratory’ implies an element-by-element, incremental assembly of a given BD-CODEX graph according to the information content listed above. Accordingly, it is assumed BD-CODEX ‘nodes’ include records plus salient attributes, (i.e., values of which condition subsequent processing). BD-CODEX ‘edges’ then include pointers to any additional resources that may be available or of interest. As described above, BD-CODICES once generated are stored in the RDB resource database 350 displayed in FIG. 3. In this manner, those portions of DATAVERSE pertinent to BD Exploration (BDE) may be rendered searchable. In effect, DATAVERSE references are rendered as a valid input to BDE. In simplest terms one might regard BDA as a process that ‘tames’ BigData.

A key point is BD-CODEX is rendered as an RDB image, uniform access to which is assured via tailored SQL/DBASE transactions. It then follows that the nondeterministic search upon which BDE is based is performed via SQL transactions. It should also be noted, as an RDB image, BD-CODEX may be encrypted. This represents a critical security consideration because: (i) proprietary results are generally expected of BDE analyses and (ii) BD-CODEX represents that singular data-component that renders BDE possible. Bluntly stated, BD-CODEX security is critical where BigData applications are considered and must therefore be protected.

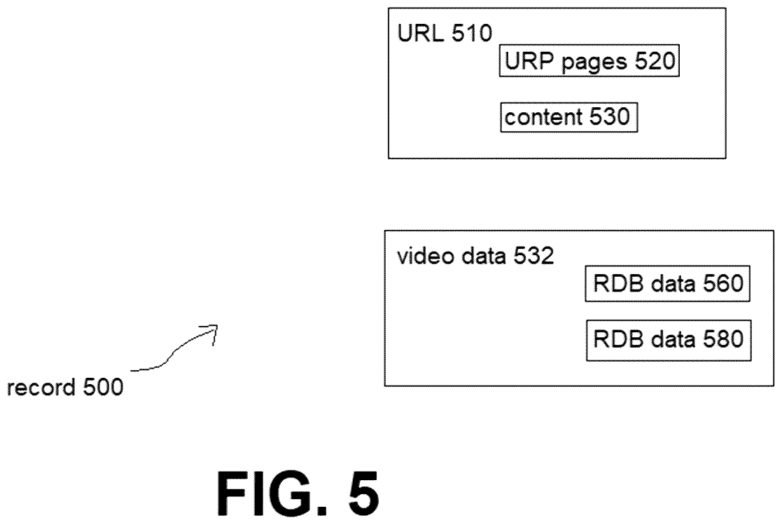

An exemplary BD-CODEX/RDB record 500 is displayed in FIG. 5. This record 500 is not intended to express all possibilities but to reveal a generic principle whereby comprehensive referencing data is provided for arbitrary content appearing at a given URL 510, including relevant URP pages 50 and specific content 530. In FIG. 5, the system is primarily concerned with video data 532, as is reflected in presence of RDB data fields 560,580 specific to the video data category. These data fields then collectively define an interface by which all data may be extracted. More generally, once discovered and added to BD-CODEX/RDB, a SQL-query will provide all information required to: (i) extract data from a given DATAVERSE-element and (ii) follow indicated references.

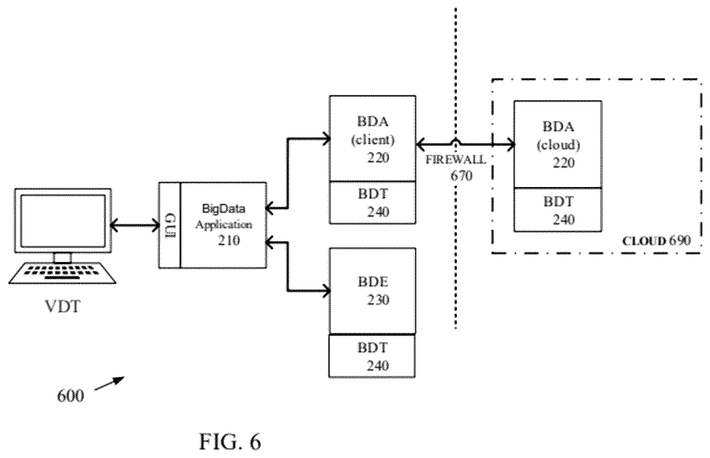

BigData Assembly at Scale. In previous discussion, the locus of BD-Assembly (BDA) is assumed to be that of the BigData application displayed in FIG. 2, presumably behind a firewall of some form (not shown). This makes sense from a security perspective, but is not maximally efficient where exascale BigData processing is being considered. In particular, it is desirable to minimize local data-storage within the context of BigData Exploration (BDE). One possibility is to have BDA processes performed all or in-part “in-the-cloud” as a SaaS application. Thus, both BD-CODEX and cached DATAVERSE-elements optionally reside on a cloud-based RDB-resource (e.g. referring to FIG. 1(a), BDE can download components of each, but now only on an “as needed” basis). Accordingly, the BigData application suite shown in FIG. 2 can be modified to show BDA as distributed to the cloud 690, as shown in FIG. 6, with process control now applied via a local thin-client. The singular advantage of such an arrangement 600 is the requisite complexity of local data-processing and data-storage resources are effectively decoupled from the scale of any BDE problem being considered. That is to say, the ‘size’ of the various BigData problems is now limited only by cloud-resources. It should be noted that despite the fact proprietary data is now external to the aforementioned local infranet-firewall, that data remains secure behind a cloud-firewall 670. Thus, the context in which the questions of BD-CODEX/BDE security are addressed have been shifted from the local infranet to some assumed cloud processing environment.

In operation, both BDE and BDA access a stored BD-CODEX image, albeit for different purposes and with distinct BD-CODEX READ/WRITE permissions, as summarized in the below table:

TABLE
BD-CODEX READ/WRITE Permissions

| Data | Process | Operation | Permission |
|---|---|---|---|
| BD-CODEX | | | |
| | BDE | | |
| | | READ | • |
| | | WRITE | |
| | BDA | | |
| | | READ | • |
| | | WRITE | • |

The intent of such READ/WRITE permissions is so that any modification to BD-CODEX graph-structure is reserved to BDA, with BDE reading BD-CODEX in order to access root-data as input to various analysis processes. However, it is entirely possible that new KDR content is discovered part and parcel of BDE processing. This new data may in turn signal a BD-CODEX structural modification, (i.e., per BDE/KBASE). In such cases, BDE initiates inter-task communication, as mediated by BigData Application executive-control, with a request for that modification. When control is then passed to the BDA task, the BDA kernel-stack will READ/MODIFY/WRITE the current BD-CODEX image as a data-recursive process. In this manner, BD-CODEX graph-structure evolves dynamically with data-discovery.

BD-System Application Architecture. Looking more closely at the BigData application suite as displayed in FIGS. 2-6, it is shown that BDE and BDA AI applications loosely integrate as independent tasks that would appear sequentially on a process timeline. This simple architectural form is motivated by an implicit assumption that BigData analysis of whatever type will follow a simple three-step process: (i) generate some initial KDR-set on a problem domain (BDE: Initialize), (ii) map BDVERSE (BDA: Generate BD-CODEX image), and (iii) explore BDVERSE based upon the current BD-CODEX image (BDE: Analysis). However, as methodological scenarios pertaining to the problem of BigData analysis are considered, it is apparent that this sequential processing model is not maximally efficient. The primary reason for this is the aforementioned process is iterative. That is, the entire process is rendered recursive based upon discovery of additional KDE-structure pertinent to the BigData problem at hand. Further, it is noted that the essential intertask data content forming communication amongst BDE and BDA tasks is BD-CODEX; as new KDR-elements (‘ΔKDR’) are discovered, those elements are passed to BDA for possible extension of the BD-CODEX image. We can model this process via a simple recursion, (for which ‘⊕’ denotes a tailored graph-operator).

$${BDCODEX}^{X} {←}_{BDA} Δ KDR ⊕ {BDCODEX}^{K - 1} \qquad ( 1 )$$

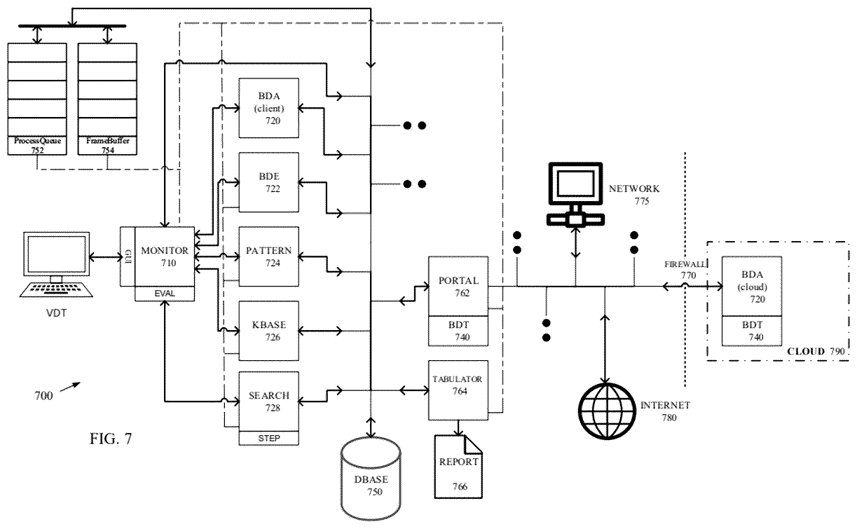

It is then noted that if ΔKDR is passed as-is to BDA, Equation (1) is rendered deterministic at the level of BDE/BDA invocation. However, Equation (1) is rendered nondeterministic wherever ΔKDR is modified prior to passage to BDA. This can occur, for example, if BDE generates a ΔKDR-set and that set is augmented to include potentially salient elements, undiscovered within the current BDCODEX image but possibly present in the as-yet-undiscovered DATAVERSE. In this case, an essential nondeterminism arises in selection of elements to be included. Further, logic controlling any such selection is appropriately encapsulated within some KBASE image. It is then concluded that BD-CODEX generation may be cast as a problem of AI goal-directed search within context of the aforementioned BDE/BDA iteration. Accordingly, the present BD System is rendered in FIG. 7, as a hierarchical AI architectural form incorporating BDE/AI and BDA/AI as subprocesses.

The BDA/Ai specific form 700 of the non-generic AI-based application (“BDA/AI”) described herein is illustrated in FIG. 7, with descriptions of each block component as follows. The BDA/AI 700 includes a MONITOR component 710, which provides AI Executive Control, including problem description/system state evaluation and task-queue assembly. The MONITOR component 710 interfaces with the BDA component 720, a BDE component 722, a PATTERN component 724, a KBASE component 726, and a SEARCH component 728. The BDA/AI 700 interfaces with a Tabulator 764 for generation of reports, 766, as desired. The BDA/AI 700 further includes an I/O portal 762 in communication with the BDT component 740, which provides the OSI transport-layer, which includes DATAVERSE access and video READ/WRITE/ARCHIVE w/compression. The I/O Portal 762 interfaces with relevant external networks 775 and the Internet 780. All of the components of the BDA/AI 700 have access to a database 750 and interface with a process queue 752 and a frame buffer 764.

Similar to the design illustrated in FIG. 6, it is desirable to minimize local data-storage within the context of BigData Exploration (BDE). Thus, one possibility is to have BDA processes performed all or in-part “in-the-cloud” as a SaaS application. Thus, both BD-CODEX and cached DATAVERSE-elements optionally reside on a cloud-based RDB-resource. Accordingly, the BDA/AI 700 shows BDA as distributed to the cloud 790, with process control now applied via a local thin-client. The singular advantage of such an arrangement 700 is the requisite complexity of local data-processing and data-storage resources are effectively decoupled from the scale of any BDE problem being considered. That is to say, the ‘size’ of the various BigData problems is now limited only by cloud-resources. It should be noted that despite the fact proprietary data is now external to the aforementioned local infranet-firewall, that data remains secure behind a cloud-firewall 770. Thus, the context in which the questions of BD-CODEX/BDE security are addressed have been shifted from the local infranet to some assumed cloud processing environment.

This BD/AI architecture 700 is intended to describe a complete system in which solution of a given BigData analysis problem is rendered equivalent to one of goal-directed search within context of the BD-CODEX recursion in Equation (1), here as implemented by iterative calls to BDE and BDA subprocesses. It is then anticipated that an increased efficiency for BD/AI relative to the application suite, as displayed in FIGS. 2 and 6, is obtained based upon: (i) BDE/BDA parallelization (re: ‘Amdahl’ processing gain) and (ii) sharing of the PORTAL/BDT resource amongst BD/AI, BDE/AI, and BDA/AI processes.

### C. BigData Exploration

By design, BigData Exploration (BDE) incorporates all processing on data elements leading to updated truth values for any logical term present in a given BigData problem statement. All such processing is defined relative to the AI processing model and problem-statement formalism employed herein. Toward this end, it is proposed that application of user-defined logical conjectures to a body of data is referenced by a BD-CODEX. Further, these logical conjectures accrue in standard predicate form, with all logical clauses expressed in CNF or DNF format. The user is thus enabled to formulate an arbitrary logical conjecture, terms of which are constituted of the aforementioned keywords, declaratives, logical relations on keywords (‘KDR’), and ancillary data references. The essential BDE problem statement is then: “Find evidence within the body of data rendered accessible by BD-CODEX either for or against a given logical conjecture.” In recognition of the fact that the BigData problem solution is constituted of a body of evidence along with a summary truth-value assessment, the implied search formalism is termed as an evidentiary search performed within context of an overarching AI-based nondeterministic search.

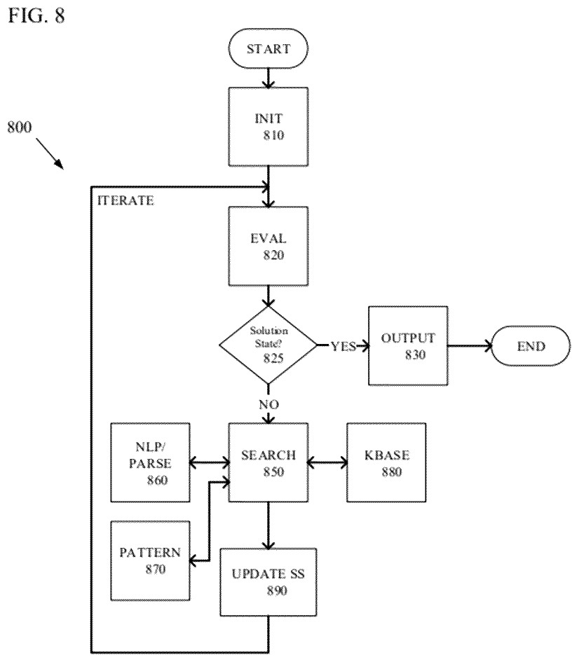

With assumption of an AI processing model for BDE, it then follows evidentiary search is necessarily performed within context of AI goal-directed behavior. The basic AI logic flow is displayed in FIG. 8, which is essentially identical to the AI System logic flow implemented by BigData Assembly.

As shown in FIG. 8, a generic AI processing narrative or model 800 includes the following steps: the system is initialized (Step 810) with application of state-variable defaults [INIT], the data is evaluated (Step 820) [EVALUATE] to determine if there is a solution state (Step 825). If the determination at Step 825 is YES, then the successful results are output (Step 830) [OUTPUT] and the process 800 terminates [END]. If the determination at Step 825 is NO, then the state in solution search space is incremented (Step 850) [SEARCH]. Then, the input datasets are assembled (Step 860) [NLP/PARSE] and pattern analyses is performed (Step 870) [PATTERN]. All knowledge-base variables are updated (Step 880) with classifier outputs [KBASE] and the solution state is updated (Step 890) and the process returns to Step 820 for further evaluation based on the updated solution state [ITERATE].

It is noted that evidentiary search assembles support for a given conjecture based upon truth-value of a logical relation in a manner distinct from any ML-based pattern-analysis. Accordingly, FIG. 8 can be modified to incorporate calculation of truth-values on logical clauses also appearing RHS in KBASE productions:

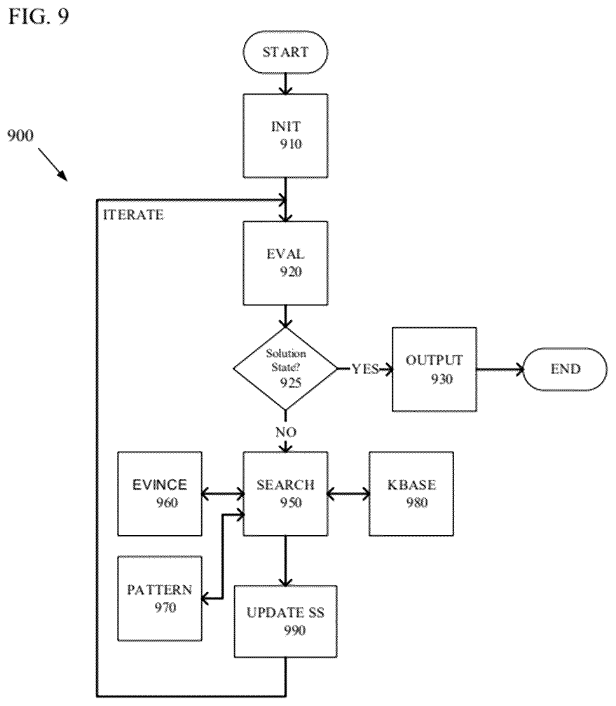

This generic processing model 800 from FIG. 8 is rendered specific to BDE in the BDE/AI process narrative with evidentiary search 900, as shown in FIG. 9. At Step 910 [INIT], the system is initialized based on: (i) local dataset, (ii) user-defined conjecture, and (iii) logical variable-to-declarative map. At Step 920 [EVAL], the solution-state is tested/evaluated to see if there is a match with any existing BDA solution set. If the determination at Step 925 is YES, then the relevant BD-CODEX is output (Step 930) and the process 900 ends. If the determination at Step 925 is NO, then the SEARCH Step 950 is taken, which generates a new web-query transactions per KBASE. A set of returned URL references is assembled and iterated and evidence analysis is applied [EVINCE] (Step 960), correlation statistics are generated and pattern analyses on generated frequency of occurrence data is performed [PATTERN] (Step 970), the KBASE is updated with classifier outputs (Step 980), and the BD-CODEX/RDB image is updated (Step 990). The process returns to Step 920 for further evaluation based on the updated BD-CODEX/RDB image [ITERATE]. As indicated, any ancillary ML-based pattern classification remains entirely consistent with evidentiary nondeterministic search.

Evidentiary Search Use Model. Evidentiary search provides a complete solution to the problem: (i) keywords, declaratives, and relations are extracted from a body of data, (ii) the user supplies a (possibly compound) logical conjecture on the set thus generated, (iii) evidence for a given conjecture is sought part and parcel of AI goal-directed solution-search, and (iv) evidence in toto is processed according to a chosen logical formalism and a report is generated. A key point here is user-supplied hypotheses are of arbitrary complexity-once a basic set of keywords and declaratives are available, the user is enabled in consideration of any WFF logical assertion on that set. A basic premise of evidentiary search as basis for BDE AI-processing is a preponderance of prospective BigData customers fit the evidentiary search use-model profile. It will be useful to consider a simple example.

Suppose organization A is interested in ascertaining whether or not some organization B is engaged in a specific behavior of one form or another. In accordance with standard procedure, organization A accesses organization B's records with use of some analytical toolset in generation of basic keywords and declaratives. It is already known on part of organization A that collectives engaged in the specified activity tend to exhibit certain relations amongst keywords and declaratives that fall into specific classes. Organization A then drafts hypotheses based upon these relations of interest and submits them to BDE via the user interface. BDE then searches all available DATAVERSE resources for evidence of such relations. Once a body of evidence is assembled, that evidence is processed in: (i) generation of confidences pertaining to truth value(s) of the aforementioned hypotheses, (ii) evaluation of a summary truth-value calculation, and (iii) report generation. Based upon results thus obtained, organization A decides upon a course of action, (e.g., whether the investigation is deemed complete and can be terminated, or alternatively whether the investigation is deemed incomplete and the investigation can proceed).

An astute reader will note that the previous example engenders some similarity to a simple web-query. However, it is useful to consider how the above example differs from a simple web-query. In simplest terms, web-queries detect instances of keywords and phrases. Query responses may also be rank ordered in terms of frequency of occurrence or even goodness-of-fit, but arbitrary logical relations of any complexity amongst keywords and phrases are not considered. It should also be noted that, in extraction of keywords and relations (KDR), evidentiary search applies an identical functionality to all input data: local, global (BigData), and user-supplied hypotheses. In practice, it is expected that an evidentiary response will be far richer: more comprehensive, structured, and focused than anything possible with a simple web-query.

As described, evidentiary search is performed as a variant on the nondeterministic search applied to the aforementioned BD-CODEX entity-attribute graph (EAG), part and parcel of the assumed AI processing model described above. It then follows, evidentiary search is itself rendered as a form of graph-search. Thus, the SEARCH process component displayed in FIG. 9 reduces to some sequence of BD-CODEX/EAG node visitations and edge traversals. In this manner, BD-CODEX defines a solution state space and the specific sequence of node-visitations defines a solution state trajectory. A key point is node traversals are guided by some metric or objective function value generated on a given DATAVERSE element in current context or pointed to by BD-CODEX:

$${N}_{RANK} ≡ {N}_{R A N K} ( \{ {k}_{i} \} , \{ {d}_{j} \} , \{ {r}_{k} \} ) {k}_{i} ∈ K , {d}_{j} ∈ D , {r}_{k} ∈ R ) \qquad ( 2 )$$

There are many possibilities in terms of a specific functional form that might be employed as a node-ranking metric. In Equation (2), a generic function is generated, returning a BD-CODEX/EAG node-rank value based upon the aforementioned keywords, declaratives, and relations (KDR-elements) cast as independent variables. It is significant that these variables appear uniformly in the original problem statement and potentially apparent in a given DATAVERSE element. This is the actual basis for gathering of evidence, either for or against a given conjecture. One particularly simple option is ‘NRANK’ tests for presence of indicated KDR elements and then ranks according to frequency of occurrence. Here it is anticipated substantial variation in metric value based upon indexing of specific subsets of KDR variables. For example, in BDA processing, perhaps only set ‘K’ might be indexed so as to obtain an initial relevance measure, while sets ‘D’ and ‘R’ are reserved to evidentiary search within context of BigData Exploration (BDE).

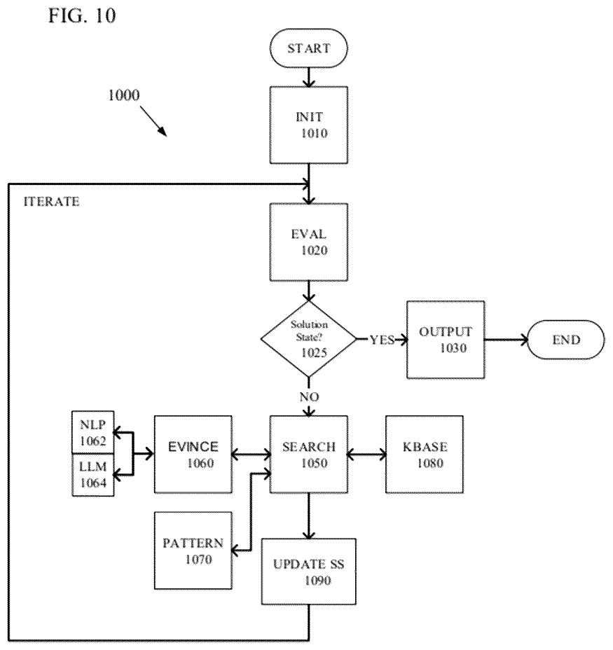

Recalling the definition of BigData Exploration (‘BDE’) as a machine process whereby DATAVERSE elements pointed to by BD-CODEX/EAG are accessed and evaluated as providing evidence either for or against a given conjecture, a specific mechanism by which this evaluation is performed will now be addressed. For this purpose, it is assumed, based upon a yet-to-be-defined data normalization process, that all DATAVERSE data-types are reduced to common textual form, that is some collection of well-formed sentences to which syntactical (Natural Language Processing; ‘NLP’) and semantic (Large-Language Model; ‘LLM’) analyses may be applied. In NLP, it is assumed that robust syntactic analysis is performed, namely, sentence parse plus extraction of diagrammatic sentence structure in terms of subject, predicate, articles, noun, pronoun, verb, adverb, etc. In LLM processing, it is assumed that robust semantic analysis is performed, namely, extraction of sentence meaning in terms of one or more simple declaratives, (e.g., thing ‘A’ is a ‘B’, or thing ‘A’ has attribute ‘B’). It then follows that NLP is applied to raw textual data in parsing of well-formed sentences and extraction of keywords. LLM is then applied to sentences, paragraphs, and prose in extraction of declaratives and relations amongst keywords and declaratives, part and parcel of establishing sentence meaning. As point of fact, these are already highly developed and readily available AI system resources that are assumed as functional blocks referenced in creation of a software architectural form. A key point is, with assumption of a uniform data representation, these processing resources enable uniform application of node-ranking metrics at any stage of a goal-directed solution-search. FIG. 9 can then be modified and the associated logic-flow narrative to include EVINCE access to both NLP and LLM generated results is shown in FIG. 10.

FIG. 10 illustrates such an NLP/LLM-enabled BDE Logic Flow Narrative 1000. At Step 1010 [INIT], the system is initialized with: (i) NLP/LLM processing on local dataset, (ii) user-defined conjecture, and (iii) logical variable-to-KDR element map. At Step 1020 [EVAL], the solution-state is tested/evaluated to see if there is a match with any existing BDA solution set. If the determination at Step 1025 is YES, then the relevant BD-CODEX is output (Step 1030) and the process 1000 ends. If the determination at Step 1025 is NO, then the SEARCH Step 1050 is taken, which generates a new web-query transactions per KBASE. A set of returned URL references is assembled and iterated and NPL/LLM evidence analysis is applied [EVINCE] (Step 1060), correlation statistics are generated and pattern analyses on generated frequency of occurrence data is performed [PATTERN] (Step 1070), the KBASE is updated with classifier outputs (Step 1080), and the BD-CODEX/RDB image is updated (Step 1090). The process returns to Step 920 for further evaluation based on the updated BD-CODEX/RDB image [ITERATE]. As indicated, any ancillary ML-based pattern classification remains entirely consistent with evidentiary nondeterministic search.

From a larger perspective, it is noteworthy that the KBASE updates indicated in the NLP/LLM-enabled BDE logic flow 1000 include calculation of aggregate statistics in terms of frequency of occurrence for all KDR elements. Thus, it is expected that any ‘solution’ generated by BDE is of a fundamentally statistical nature and therefore subject to statistical sampling convergence criteria per an implicit application of the law of large numbers (LLN). It then becomes apparent that it is the exascale nature of BigData itself that enables a reduced variance estimation on all KDR elements based upon a preponderance of data. Recalling the fact logical conjectures present in any BDE problem statement are expressed in terms of KDR elements, it then follows that a corresponding reduced variance estimation on truth values associate with those conjectures is expected. Among other implications, this result confirms an essential advantage expected of BDE processing on BigData. In other words, “Where statistics are concerned, more (exascale) data is better.”

At a more detailed level, yet another implication of the statistical nature of KDR elements is each such element is associated with a distinct probability or confidence distribution. Architecturally, based upon a simple locality-of-reference consideration, all such distribution instances and derived statistical estimates are assigned to KBASE for most efficient update of all logical productions in which KDR elements appear. Even more significantly, any logical inference performed on KBASE productions must support truth-value calculation on statistical estimators. In particular, the result of any logical inference must then include an update of an associated probability or confidence. In simplest terms, it is preferred to choose an inference engine capable of supporting both statistical representation and logical inference on what is now understood as variables possessed of statistical attributes.

There are a number of possibilities that one might consider with regard to mathematics that the BDE inference engine will employ. Two obvious alternatives are Bayesian Inference and logical inference based upon the mathematics of Fuzzy-Logic. Of the two, Fuzzy-Logic is arguably the most general and will be assumed to be used hereinafter. As already noted, the Fuzzy-Logic formalism includes instancing of a confidence distribution representation for all logical variables along with a schema for calculating or updating predicate confidences. Further, Fuzzy-Logic incorporates simultaneous support for both conjecture and ~conjecture (“conjecture negation”). While there is no particular requirement for this latter capability, independent assessment of conjecture and conjecture negation constitutes an advantage based upon the fact evidentiary support for each may in fact be different. Further, capability for an increased efficiency is implied based upon the fact both calculations may be opportunistically performed during a single BD-CODEX/EAG node visitation.

A BDE problem representation will typically include an initial KDR set with conjecture, as shown in Equation (3):

$$CONJ ( KDR ) ⋀ KDR \qquad ( 3 )$$

$$KDR = K ⋃ D ⋃ R \vert K = {\{ {k}_{i} \}}_{i} , D = {\{ {d}_{j} \}}_{j} , R = {\{ {r}_{k} \}}_{k}$$

In normal usage, KDR is derived from some local dataset of interest while ‘CONJ(KDR)’ represents an arbitrary logical conjecture, (i.e. expressing a truth-value) in which KDR elements appear either as parameters impacting the truth value of a logical variable, or as logical variables themselves. Here it will be assumed that CONJ(KDR) is expressed in CNF or DNF standard form where each term is itself a logical clause expressing a component truth-value set forth in the following Equations (4a) and (4b):

$${CONJ}_{CNF} ( KDR ) = {C}_{1}^{CNF} ( KDR ) ⋀ {C}_{2}^{CNF} ( KDR ) ⋀ \qquad ( 4 a )$$

$${CONJ}_{DNF} ( KDR ) = {C}_{1}^{DNF} ( KDR ) ⋁ {C}_{2}^{DNF} ( KDR ) ⋁ \qquad ( 4 b )$$

Note, where BDE is considered, either convention may be assumed with equal efficacy. In either case, each KDR element is mapped to a distinct distribution. It then follows that each term appearing in Equations (4a) and (4b), RHS and LHS, is associated with a distinct distribution. It also follows that any evaluation or modification of these distributions must be performed by an inference engine implementing the chosen logic formalism. In operation, BDE will scan the DATAVERSE element pointed to at a BD-CODEX/EAG node visitation for appearance of KDR elements, tabulate cumulative instance counts, and subsequently update KBASE-resident KDR distributions per a recursion expressing recalculation of all distributions, here based upon an aggregation of KDR detection events set forth in Equation (5):

$$DIST ( {KDR}^{K} ) {←}_{BDE} DIST ( {KDR}^{K - 1} , Δ KDR ) \qquad ( 5 )$$

With this iterative step, Equations (4a) and (4b) are updated by the BDE inference engine per a node-visitation path generated on BD-CODEX/EAG within context of nondeterministic solution search. As previously discussed, this node-visitation path may be extended indefinitely per the previously discussed BDE logic flow, or alternatively terminated once a solution state is reached.

There exist a variety of options with regard to selection of BDE termination criteria, as expressed in FIG. 10. A particularly simple choice is termination at a point at which the ‘ΔKDR’ correction indicated in Equation (5) falls below a specified threshold:

$$Δ KDR \leq {C}_{COVERAGE} \qquad ( 6 )$$

Intuitively, the above Equation (6) is understood in terms of an assertion that no further data need be processed. With no further update to Equations (4a) and (4b), BDE switches to a terminal state.

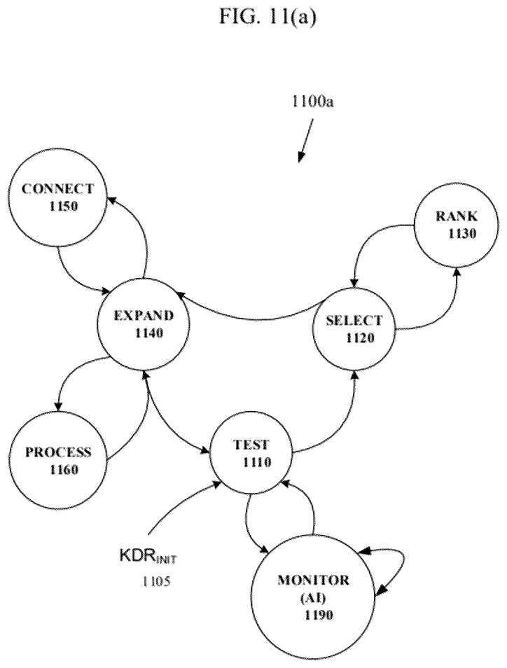

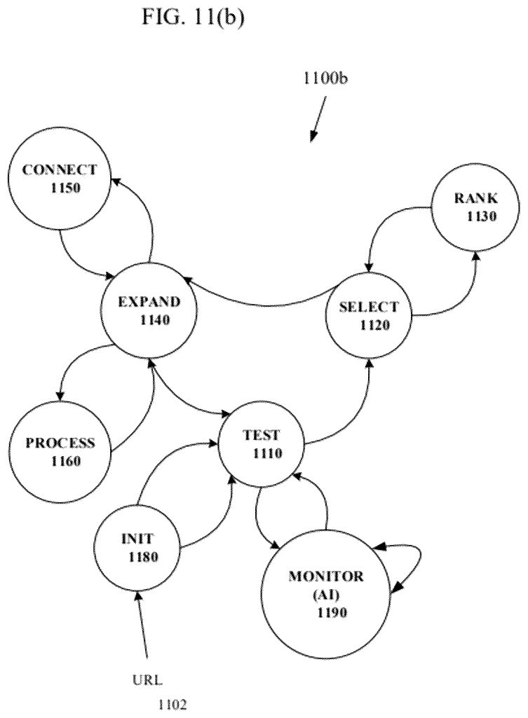

The BDE nondeterministic search can now be described in terms of a state transition diagram (‘STD’) 1100a, illustrated in FIG. 11a. BDE solution-search is illustrated as a state transition diagram 1100 that accepts an initial KDR set 1105 for initialization. Typically, this set 1105 is derived from an existing list of keywords, declaratives, and extracted from DATAVERSE elements processed via some alternate means. The state transition diagram 1100 includes the following states: TEST 1110, which tests for a matching solution set relative to the initial KDR set; SELECT 1120, which picks a daughter-node for expansion; RANK 1130, which rank-orders a daughter-node based on relevance/information density; EXPAND 1140, which opens a ‘daughter-node’ address list; CONNECT 1150, resolves an address/URL associated with the initial KDR set; and PROCESS 1160, which detects KDR elements from the initial KDR set.

Although convenient and possibly more efficient, this initialization 1105 is not a required input for BDE processing. Rather, as displayed in FIG. 11(b) hereinafter, solution-search may be bootstrapped from an initial scan of any DATAVERSE element known or even surmised to be relevant. In such case, only a URL 1102 need be provided to INIT state 1180. It should also be noted that an AI MONITOR state 1190 exists in both state diagrams of FIGS. 11(a) and 11(b). AI MONITOR state 1190 presages consideration of a hierarchical control-envelope implicit to the logical flow 1000 displayed in FIG. 10. On this basis, FIG. 10 is seen to inform development of an architectural form for BDE.

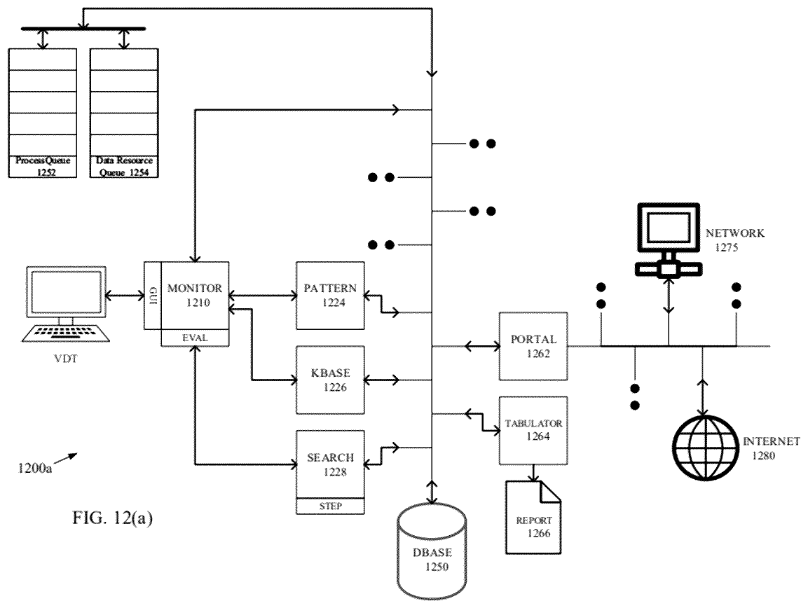

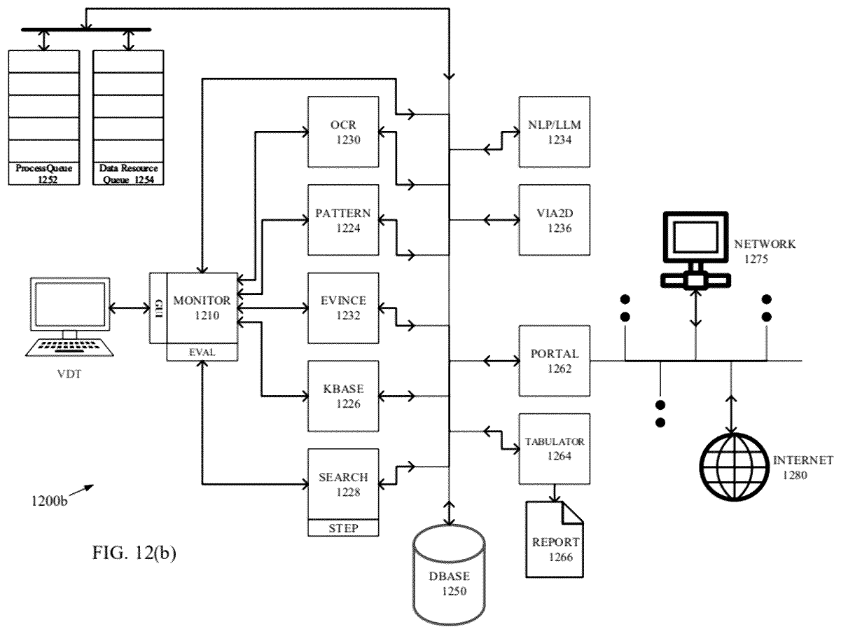

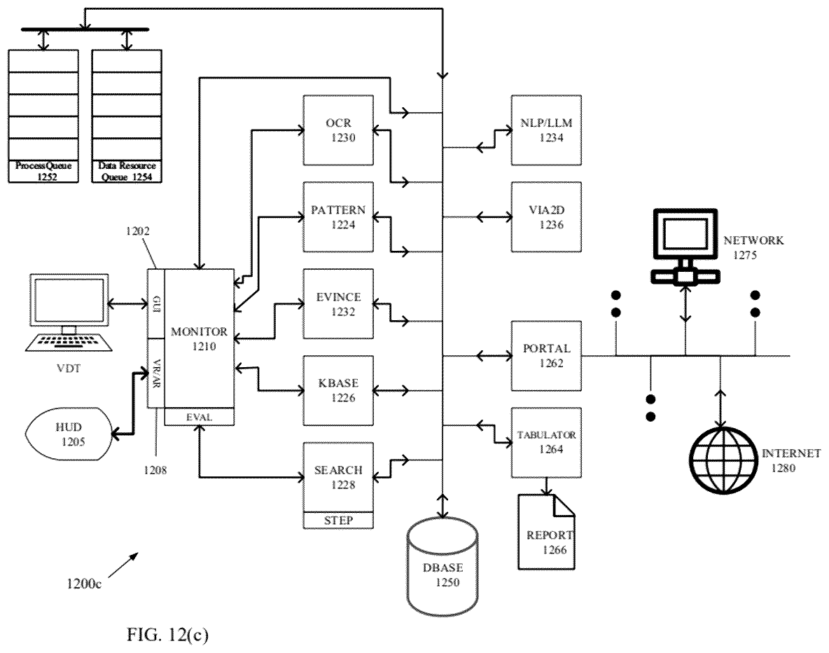

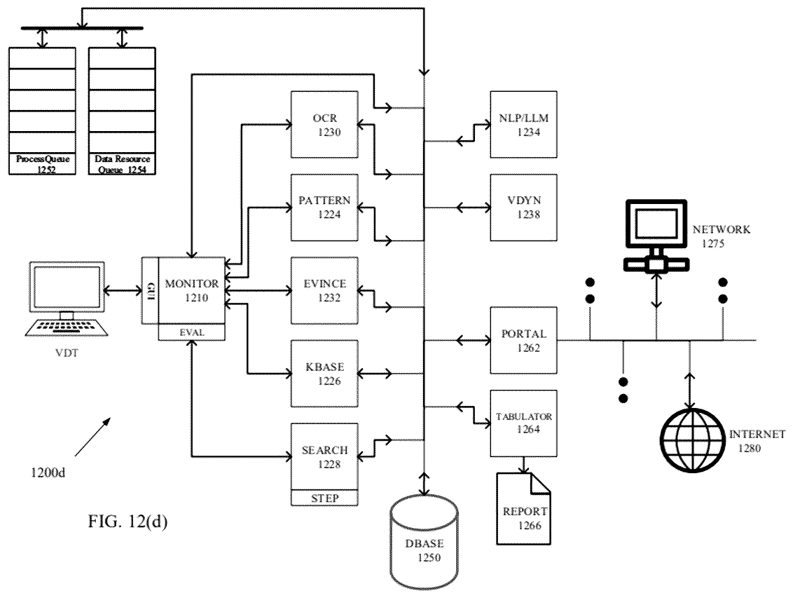

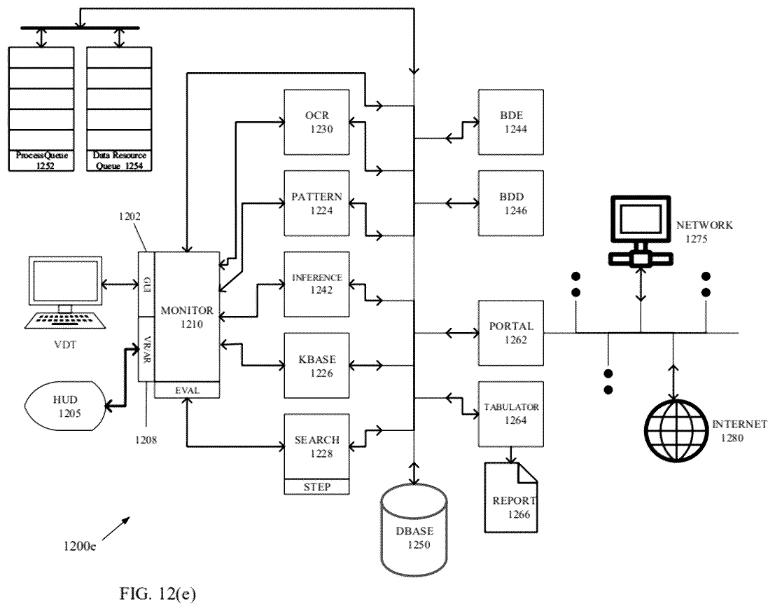

BDE System Software Architecture. As previously discussed, BDE is implemented per the goal-directed AI-processing model depicted in FIG. 10. Thus, in construction of a BDE software architecture, a standard AI architectural form 1200a, as shown in FIG. 12(a), is illustrated. Most notably, the supervisory executive control implied by the EVAL::SEARCH::EVINCE processing loop from FIG. 10 is rendered explicit by MONITOR control linkages. Specifically, MONITOR 1210 is the primary process that links to and controls the following subprocesses, namely, PATTERN 1224, which provides ML-based classification on any content appearing in the data-resource queue, KBASE 1226, which provides logical productions with confidence distributions available to MONITOR processing (e.g. control-vector, generation, EVAL, process-schedule, etc.), SEARCH 1228, which provides BDE goal-directed nondeterministic-search with BD/CODEX EAG node-expansion, PORTAL 1262, which provides a Network/WEB Access Gateway to available networks 1275 and the Internet 1280, generally, and TABULATOR 1264, which provides Report 1266 generation. All of the main components are connected with and have access to a suitable database 1250.

In most general terms, MONITOR executive control enables: (i) GUI-based WFF definition and representation of a BigData exploration problem and (ii) assembly of all processing resources necessary to solve that problem according to the AI goal-directed search processing model. It is also noted, as a supervisory process, MONITOR scratchpad (local memory representation) will incorporate an array of memory resources using Process Queue 1252 and Data Resource Queue 1254. These queues include, more specifically, Subprocess schedule queue, Local data processing queue, Problem Representation, SOLUTION-STATE, and OSI/TRANSPORT schedule queue.

Turning now to FIG. 12(b), a BDE-specific AI architectural form 1200b is illustrated. In this architectural form 1200b, MONITOR 1210 enables implementation of the previously described AI System Logic Flow 800 shown in FIG. 8. Thus, adding all required BDE subprocessing resources to form 1200b, a comprehensive implementation of the NLP/LLM-enabled BDE Logic Flow plus the BDE solution-search state-transition diagrams (STD) displayed in FIGS. 11(a) and 11(b) is obtained.

Specifically, MONITOR 1210 is the primary process that links to and controls the subprocesses previously discussed with regard to FIG. 12(a). MONITOR 1210 is the primary process that links to and controls the additional BDE subprocesses, namely, LLM 1234, which provides semantic analysis (sentence meaning in terms of WFF logical clause on KDR elements) and NLP (also shown as part of component 1234), which provides syntactic analysis (sentence structure [diagrammatic representation]), OCR 1230, which provides RASTER-to-TEXT conversion, EVINCE 1232, which provides Goal-Directed nondeterministic search on BD/CODEX EAG, and VIA2D 1236, which provides Video, Image, Audio to Data conversion.

All of the BDE-specific subprocesses described above are subject to direct MONITOR control. Thus, aside from providing rational basis for effective solution of a given BDE problem statement, a singular advantage to be associated with the architecture displayed in FIG. 12(b) is an ability to obtain Amdahl processing gain based upon parallelization of all subprocesses subject to MONITOR control. More concisely, if it is assumed that application port to a sufficiently capable multicore compute platform is used, each of these BDE-specific subprocess may be associated with a distinct thread, the entire set of which is subsumed under an overarching scatter-gather process model. Moreover, this feature may be extended to a tailored thread-pool to be associated with the solution-search STD, as displayed in FIGS. 11(a) and 11(b). In doing so, BDE solution-search is first expanded as a thread-pool and then parallelized via concurrent mapping of daughter-nodes appearing within context of the previously described BDE/CODEX/EAG graph-search.

It should also be noted that the VIA2D subprocess 1236 enables any video, image, and audio data appearing at any BD-CODEX node to be converted to textual format. The derived advantage of this process is twofold: (i) direct access to a preponderance of BigData container types and (ii) synergistic data-content fusion per KBASE content for all datatypes appearing within context of goal-directed solution-search. VIA2D 1236 is presented here as an available technical component. A detailed technical description for VIA2D will be presented elsewhere.

VR/AR User Interface for BDE. Many of the technical challenges associated with BDE processing are related to the exascale nature of the data appearing at BDE input, in combination with formal complexity of the AI-based nondeterministic search applied to the BD-CODEX entity-attribute graph (EAG) discussed above. More specifically, it is expected that there will be: (a) High volume of query-generated datasets; (b) Analytical datasets exhibiting complex interrelationships, and (c) Highly complex decision traceback.

Of these three items, it is already understood that with the first per combinatorial expansion of the KDR-set, each element exhibits a possible data scenario. However, the second and third items suggest that BDE processing outputs can at least, under some conditions, be expected to exhibit diversity and complexity on par with the exascale nature of the input. This begs a question concerning how any user might usefully apprehend all the information being generated by BDE. We are thus led to consideration of the BDE user interface (UI), whereby three options are apparent: (a) a Command line, a GUI, and VR technology.

Command line is simplest, but also the most ‘opaque’ in the sense contextual interrelationships are not immediately apparent. Bottom-Line, this option is most demanding in terms of user interaction and specialist-level expertise.

GUI is a step-up in terms of displaying domain structure and interrelationships. However, navigation amongst data-nodes is rendered complex due to an inherent 2D flattening of what is essentially a non-planar graph structure. Thus, it is anticipated that such GUI would provide an extensive menu-driven interaction on part of users due to an inherently layered presentation of data-structure (i.e., by which only partial views of data-relationships are available).

VR technology enables an expanded view based upon a dynamic 3D perspective in which all data-interrelationships, (e.g., the complete BD-CODEX entity-attribute graph [EAG]), are in-principle available within a single unified context. On this basis, data navigation is highly simplified.

While BDE complexity in terms of generating search trajectories is apparent, how this complexity is transformed at BDE/UI has not yet been addressed. Recall BDE processing hinges upon definition of a KDR-set that includes keywords, declaratives, and relations amongst keywords and declaratives. In processing on any DATAVERSE element pointed to by BD-CODEX/EAG, sample statistics are gathered on all apparent KDE elements and, as a given solution-search trajectory is traversed, statistics are aggregated and rank-ordered along that path. Each KDR estimator then defines a feature, the value of which is projected into a tailored vector space in which features appear as axes. Once in this form, various correlative analyses may be performed in: (i) identification of new KDR elements or (ii) substantiating relevance of relations already identified. It then follows that high-order dimensionality of this feature space are expected. [As an aside, this is also the essential problem of cluster analysis and visualization in design of machine learning (ML) classifiers].

Despite the high dimensionality of BDE feature-space data, data scientists have developed technical plot representations enabling 3D visualizations of higher dimensional data based upon nonlinear mappings that effectively collapse ‘N’ feature-space dimensions to a 3D representation, which of course can be visualized. BDE/VR is then the process by which these technical plots are rendered to the user. It is then anticipated that the inherent simplicity and intuitive nature of the VR interface will relax any need for data scientist's level of expertise or intervention in terms of generation and manipulation of the various BDE data representations.

In FIG. 12(c), BDE/VR 1208, linked to a HUD 1205, and BD/GUI 1202 are displayed as mutually optional based upon an expectation they will each synergize effectively with the other. However, it should be noted that a pure VRUI version is also possible.

### D. BigData Discovery

In previous discussion, BigData Discovery (‘BDD’) is defined in terms of identification and processing of new keyword, declaratives, and relations (i.e., KDR set-elements) appearing within context of BDE nondeterministic search). The means by which these new elements are discovered is the previously discussed evidentiary search mechanism, but with exception new KDR-elements are by definition absent from a current KDR-set or BD-CODEX representation. Thus, it is possible to discern a subtlety in that new KDR-elements accrue as result of the fact evidentiary search engenders processing of any keyword associations appearing at a sufficiently high rank-order, (i.e., along with those new declaratives and relations generated on that keyword). BDD then references the total process by which BD-CODEX is augmented via the iteration displayed in Equation (1). As previously discussed, BDD is appropriately cast in terms of goal-directed solution-search on any expansion of BD-CODEX. This is motivated by the fact that, aside from possible generation of an expanded EAG node-order, an entire BDE solution-state trajectory may be globally reevaluated or reprocessed within context of BDE solution search. As such, this constitutes a problem of recursion on already developed solution state trajectories, in essence a state traceback. This in turn implies necessity for presence of hierarchical control-linkages sufficient to iterative restatement of both BDA and BDE problem representations. Given an applicable KBASE representation in this context, this leads to consideration of BDD as an intelligent agent (‘BDD/AI’) appearing as but one component within a processing hierarchy that is also AI.

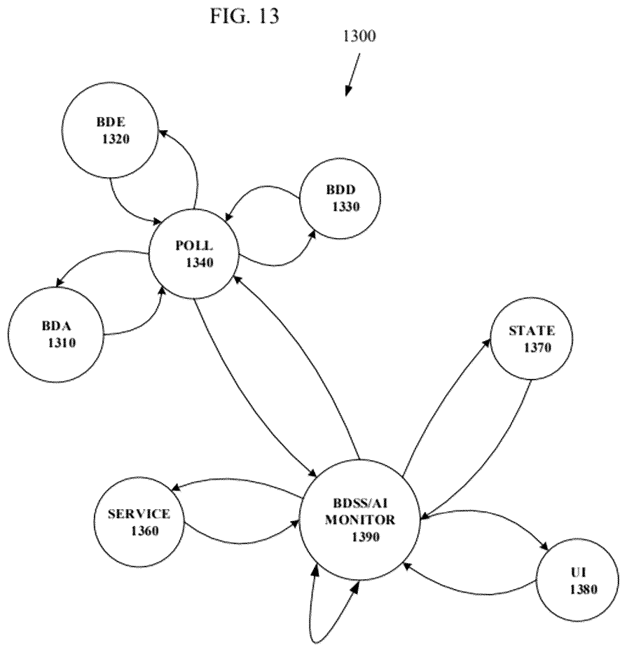

An architectural form for BDD/AI 1200d is displayed in FIG. 12(d) for which a commonality of functional blocks amongst BDA, BDE, and BDD is immediately apparent, except component VIA2D 1236 is replaced by component KYDN 1238. This commonality is driven by two considerations: (i) the generic nature of AI goal-directed problem-representation and solution-search and (ii) necessity of direct access to data elements in whatever form they might appear within context of that solution-search. However, it should be noted KBASE contents and MONITOR-resident problem statements, along with associated solution states and trajectories also residing on MONITOR, will be unique to each. In particular, where BDD/AI 1200d is integrated as a subprocess within an all-encompassing BigData Software System (‘BDSS’), the EXPAND nodes displayed in FIGS. 11(a) and 11(b) are elevated to a series of BDA and BDE service requests per the state transition diagram model 1300 displayed in FIG. 13, described hereinafter. These requests are then packaged as a work unit per BDSS/KBASE, emplaced upon the BDSS process queue, and then serviced by series of tailored calls to BDA and BDE subprocesses under direct BDSS/MONITOR control.

The BDD state transition diagram model 1300 is displayed in FIG. 13. can now be described in terms of a state transition diagram (‘STD’) 1100a, illustrated in FIG. 11a. The state transition diagram 1300 includes the following states: BDA 1310; BDE 1320; BDD 1330; POLL 1340, which provides Subprocess thread-pool management; SERVICE 1360, which provides a Package/Enqueue service work-unit; STATE 1370, which Evaluates BDSS state; and UI 1380, which Generate BDSS/UI display. BDSS/AI MONITOR state 1390 presages consideration of an implicit, hierarchical control-envelope similar to the MONITOR process/component used by BDE.

It is noteworthy that the commonality amongst BDA, BDE, and BDD architectural forms engenders performance ramifications for any software implementation that might be considered based upon the fact all three subprocesses are implemented per a common thread design template mapped to a single thread-pool. Thus, a substantial flexibility is afforded in terms of process timeline design and possibility of leveraging process concurrency. Accordingly, it is noted in FIG. 12(e) that integration of BDA (using INFERENCE subprocess 1242), BDE 1244, and BDD 1246, as subprocesses within a total BigData Software Solution (BDSS), can be achieved by which a system-level Amdahl gain may be realized, depending upon specific concurrencies expressed amongst threads to which BDA, BDE, and BDD processes have been mapped.

It is further noteworthy that the BDSS architectural form evinces further differences relative to BDA, BDE, and BDD forms in that all access to BigData Transport (BDT), DBASE, Report (Generation) are virtualized as services within the BDSS processing hierarchy. This implies all subprocess access to these resources is mediated by BDSS as a service request. Accordingly, direct access to these services is not required within BDA, BDE, BDD sub-architectures. Rather, the BDSS process queue is stratified and partitioned according to an associated subprocess ID referencing each of BDA, BDE, and BDD. The BDSS/UI is also virtualized in such manner that the user may interrogate and interact with any subprocess via the polled data structure passed to each thread. In this manner, BDSS/UI is also rendered context-sensitive. In particular, the VR/AR HUD previously proposed for BDE/AI/UI is thus rendered available to BDSS/UI.

For purposes of illustration, application programs and other executable program components such as the operating system may be illustrated herein as discrete blocks, although it is recognized that such programs and components reside at various times in different storage components of the computing device, and are executed by the data processor(s) of the computer. An implementation of media manipulation software can be stored on or transmitted across some form of computer readable media. Any of the disclosed methods can be executed by computer readable instructions embodied on computer readable media. Computer readable media can be any available media that can be accessed by a computer. By way of example and not meant to be limiting, computer readable media can comprise “computer storage media” and “communications media.” “Computer storage media” comprises volatile and non-volatile, removable and non-removable media implemented in any methods or technology for storage of information such as computer readable instructions, data structures, program modules, or other data. Exemplary computer storage media comprises, but is not limited to RAM, ROM, EEPROM, flash memory or memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent system (e.g. expert interference rules generated through a neural network or production rules from statistical learning).

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs may be implemented in a high level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, mobile phones, softphones, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I hereby claim:

1. A system for organizing, searching, analyzing, and retrieving a previously unstructured data record from a voluminous group of unstructured data records, comprising an assembly component, an exploration component, and a discovery component, wherein:
In response to a given conjecture, the assembly component initiates a process whereby a URL reference along with a set of defining attributes associated with the given conjecture are combined to create an entity-attribute graph (EAG) representation, referred to as a DATAVERSE, wherein the DATAVERSE is further processed to create a SQL/RDBMS image, referred to as a BD-CODEX, based upon mere appearances of keywords, simple declarative statements, logical relations on keywords, and ancillary data references that have evidentiary bearing upon the truth-value of the given conjecture, whereby the previously unstructured data record is converted into a searchable form based upon metric relevance to a given first problem statement and interconnection with ancillary data elements associated with the first problem statement;
Thereafter, the exploration component and the discovery component are able to retrieve the converted data record in response to a query having metric relevance to a given second problem statement and interconnection with ancillary data elements associated with the second problem statement.
